(19) United States
(12) Patent Application Publication
(10) Pub. No.: US 2018/0300771 A1
(43) Pub. Date: Oct. 18, 2018

(54) MAINTAINING PAGE INTERACTION FUNCTIONALITY WITH OVERLAY CONTENT

(71) Applicant: GumGum, Inc., Santa Monica, CA (US)

(72) Inventors: Gwendoline Roger, Los Angeles, CA (US); David Mejorado Hernández, San Francisco, CA (US); Merrill Bajana, Los Angeles, CA (US)

(21) Appl. No.: 15/951,762

(22) Filed: Apr. 12, 2018

Related U.S. Application Data
(63) Continuation of application No. 62/485,838, filed on Apr. 14, 2017.

(51) Int. Cl. G06Q 30/02; G06F 17/30; G06F 3/0484

(52) U.S. Cl. CPC G06Q 30/0277; G06F 3/04842; G06F 17/3089; G06F 17/30887

(57) ABSTRACT

Systems and methods are described for dynamically presenting overlay content on portions of an image or video within a page or other user interface, while allowing at least partial user interactivity with the underlying image or video. Overlay content may be displayed within a container object that is placed over the underlying page image or video. The visible overlay content may be smaller than and/or differently shaped than the container object (such as by not being rectangular and/or by the overlay content including transparent portions), such that some of the underlying image or video remains visible beneath the overlay content and the container. When a user selection is made within the container object, the responsive action to be performed by the client computing device may be either an action identified in the original page code or an action associated with the overlay content, depending on location of the selection.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims benefit of U.S. Provisional Patent Application Ser. No. 62/485,838, entitled “Systems and Methods for Maintaining Content Interaction Functionality with Overlaid Advertisements,” filed Apr. 14, 2017, which is hereby incorporated by reference in its entirety.

### BACKGROUND

Publishers of various types of news, editorial or other content often include or incorporate images and videos in their publications. For example, a news article presented in the form of a webpage may include photos or other images within the webpage, in addition to the text of the news article itself. An advertisement may be presented near, on, over or within one or more of these images, such as by overlaying an advertisement graphic and/or advertisement text over a portion of an editorial image or other image on the publisher's webpage. For example, according to existing systems, a rectangular advertisement is sometimes embedded within (or overlaid on top of) a portion of an underlying image. The rectangular advertisement may appear, for example, centered near the bottom of the image, with the majority of the image visible above the advertisement. If a user viewing the webpage or other user interface makes a selection (such as by a mouse click or tap gesture) within the rectangular advertisement, the user's browser or other application displaying the webpage or other user interface may load a page associated with the advertisement. This may occur, for example, by the browser sending a network request for content having a uniform resource identifier (“URI”) that was previously associated with the selected advertisement.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIGS. 1A and 1B are flow diagrams of an illustrative method for displaying an advertisement or other overlay content on an image or video within a webpage or user interface, and for handling user selection events in association with the displayed overlay content.

FIG. 2 illustrates a webpage before and after advertisements are displayed as overlay content on (or within) images on the page as a result of code executed by a client device.

FIG. 3 illustrates two sample instances of a “frame” advertisement unit, according to one embodiment, displayed as partially transparent overlays on two differently sized images.

FIG. 4 illustrates a sample display of an overlay “frame” advertisement displayed on an image embedded within a webpage or application user interface, as well as a graphical representation of the areas of the display in which a user selection event will register as a selection of the advertisement.

FIG. 5 is a system block diagram of a computing environment suitable for use in various embodiments of the present disclosure.

### DETAILED DESCRIPTION

Generally described, aspects of the present disclosure relate to advertisement or other supplemental overlay content that is dynamically displayed over or within an image or video that appears on a webpage or other user interface. Aspects of the present disclosure further include handling user selection events (such as mouse clicks, tap gestures, swipes or other actions) in a manner such that selection actions performed within transparent portions of overlay content are effectively passed through to the underlying image or page content to be processed in accordance with a publisher's original page code. Embodiments disclosed herein enable advertisers to create new types of in-image or in-video advertisement content that is not confined to a rectangular portion of an image or video, and instead may “frame” an image or video by including advertisement or other overlay content on the top, bottom and sides of the image or video (or may be otherwise shaped such that the advertisement cannot be contained within a rectangle without significant empty space within the rectangle).

One problem with attempting to use existing technology for a “frame” visual effect for an in-image overlay advertisement or other overlay content is that user selection events that a user intends to direct to the underlying image (such as the user attempting to use a mouse click or tap gesture to follow a link or other action associated with an image behind an advertisement) may be essentially swallowed or blocked by a transparent container that is used to present the advertisement or other overlay content over the image. For example, using existing techniques, displaying overlay content that appears on top of a portion of an image or video on a webpage typically involves displaying the overlay content in a manner whereby a container is positioned within the image to cover a portion of the image with the overlay content. For example, code may place a rectangular container in the bottom center of the image and then fill that container in its entirety with a “banner” advertisement. Any user selection actions within the portion of the image that is covered by the advertisement's container will be treated by the client device's browser as a selection within the container, as opposed to a selection of the underlying content of the original page (such as the image beneath or behind the advertisement or other overlay content).

Using existing techniques, if an advertiser chose to present an irregularly shaped advertisement as overlay content within a rectangular container with the remaining portions of the container transparent (e.g., the underlying image remaining visible behind the container), the transparent portions of the container would still block user interaction with the portions of the image behind the container. This may lead to frustration for both the user (who intended to select the underlying image as opposed to the advertisement) and for the publisher of the page (because the publisher's intended page functionality was blocked by the advertisement).

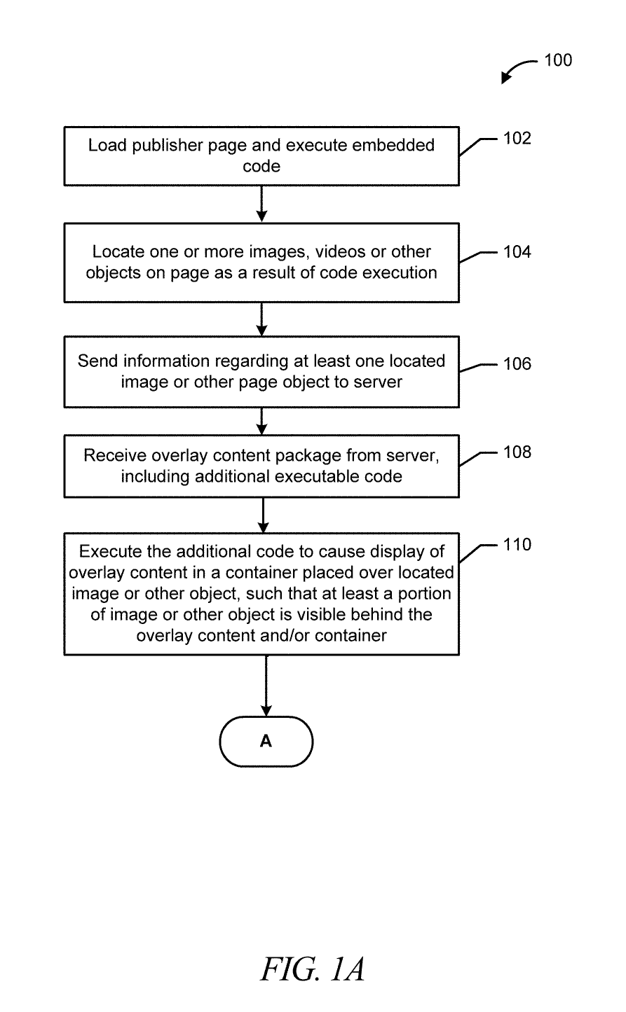

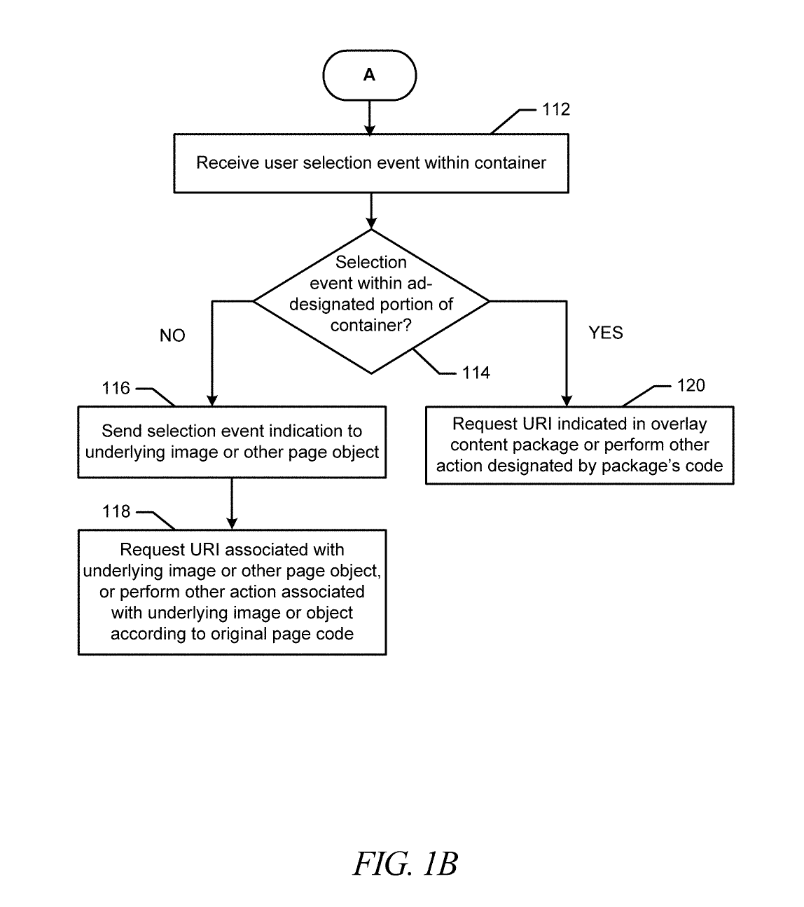

FIG. 1A is a flow diagram of an illustrative method 100 for displaying an advertisement or other overlay content on an image or video within a webpage or user interface (such as a user interface presented for display by an application operating on a user's computing device). The illustrative method may be implemented by a client computing system, such as client computing system 303 that will be described below, based on code and advertisement content received from an advertisement service's server, such as computing system 302 that will be described below. The illustrative method 100 begins at block 102, where the client device loads a publisher's page and executes code included within the page. The code of the page may include code, such as JavaScript, that is configured to add advertisement or other dynamically determined content to the page when the page is loaded on a client device. For example, advertisements may be dynamically added to an image on a publisher's page when the page is loaded for display on a client device as a result of code that instructs a client's browser or another application to communicate with an advertisement server or other network-accessible computing system. For example, advertisement content may be served based in part on a JavaScript tag that a publisher includes in the publisher's page code at the direction of an operator of an advertisement service. In some embodiments, the tag may be placed directly in a webpage's HTML, such as in the footer of the HTML. In other embodiments, the JavaScript may be loaded through a publisher's ad server. When a client device's browser loads the page, the JavaScript or other code placed within the HTML or other page code may cause the browser to request additional code from a server or other computing system operated by an advertisement service (such as computing system 302, that will be described below).

Next, at block 104, the code of the page (or code received from a server subsequent to the initial page load as a result of executing the initial code) causes the browser to locate one or more images (or videos or other page objects or media items, depending on the embodiment) within the page. The code may, for example, search the page for images or other media items that are potentially suitable for placing an advertisement over or within. For example, the code may consider the size of the image, name of the image, metadata associated with the image, and/or contextual information determined from the surrounding text of the page. In some embodiments, the client-side code may perform an initial cursory consideration of an image's suitability for advertisement placement, with a more in-depth analysis subsequently performed by a server. Accordingly, at block 106, the code may then cause the browser to send information regarding one or more of the located images (e.g., potentially suitable images for advertisement placement), videos or other objects or elements on the page to a server, such as a server operated by an advertisement service that handles advertisements for a potentially large number of different advertisers. The sent information may include information regarding the page content, the publisher, and each image (and/or video or other media item considered an object of interest in a given embodiment) identified on the page as potentially suitable for advertisement placement or other content overlay. The data sent with respect to each image may include, for example, image metadata, image dimensions, image name, the location of the image in the page, and/or other information.

When the server receives the image and page data from the client device, the server may analyze the received information to determine whether to display an advertisement in association with any of the images on the page in the given instance, and if so, may select an advertisement to display (not illustrated in FIG. 1A). The server may select an image as appropriate for advertisement placement based in part on a determination that the image is within a certain size range (e.g., being within a certain aspect ratio range, and having dimensions between a predetermined minimum and maximum size). Whether to associate an advertisement, as well as which advertisement to associate, with a given image may be selected based on a variety of factors. Factors or steps in the analysis may include, but are not limited to, one or more of: contextual page analysis, keyword analysis, image naming conventions, image metadata analysis, image recognition (e.g., identifying that a certain real-world object is depicted in a photograph, identifying a company logo within the image, determining that an image meets safety criteria for lack of nudity, etc.), licensing information (e.g., determining that the image has been licensed for advertisement placement), machine learning, real-time advertiser bidding, and/or other considerations or methods. As is known in the art, various advertisers may each set their own criteria that must be fulfilled in a given instance in order for a particular advertisement to be displayed on a given image or page.

Once the server selects an advertisement or other overlay content to associate with an image on the page, the server may retrieve or assemble a package that includes one or media assets (such as images, video data and/or other visual media assets), along with code that can be executed at the client device and which causes the client device (in combination with code previously delivered to the client device) to present the advertisement and/or other overlay content for display. In one embodiment, the package may include, for example, HTML, JavaScript, JavaScript Object Notation (“JSON”), and image assets that can be assembled by the client device according to code in the package (e.g., according to the HTML, JavaScript and JSON portions of the package) to form a “frame” or other overlay content that may surround an image on the page. The package may include (such as in a JSON portion of the package) advertisement tracking data (including, for example, tracking pixels, which are known in the art), as well as information regarding a URI to be requested if the advertisement is “clicked” or otherwise selected by a user. In some embodiments, the package may include additional information, such as video or animation data, sound files, and/or links to additional third-party hosted content for incorporation into an overlay content display. For example, animation data and/or code associated with the overlay content may be interpreted or executed by a client device to cause the appearance of the displayed overlay content to change over a set time period (such as a frame shape or other content gradually moving into place over an initial ten second period) or in response to user action (such as causing magnification or movement of a portion of the overlay content upon detection that a user has hovered a cursor over the portion). The portion(s) of the container that allow pass-through functionality to the underlying page object may accordingly change over time to match the display positions of the visible overlay content.

It will be appreciated that a “frame” effect is just one possible display style that can be utilized according to the methods described herein, and that aspects of the present disclosure are useful and provide improvements over the prior art with respect to a wide range of overlay content display styles, particularly for non-rectangular overlay content. For example, in some embodiments, aspects of the present disclosure may enable display of non-rectangular overlay content that includes transparent portions (such that underlying page content is visible beneath the portions) having a variety of shapes. The transparent portions may be positioned over one or more edges of the underlying page object (such as the topmost, bottommost, leftmost and/or rightmost portion of an underlying image or video) or within an internal portion of the underlying image or video (such that visible portions of an underlying image are surrounded on every side by overlay content). Another example of overlay content display styles that may be implemented with appropriate pass-through selection functionality according to aspects of the present disclosure include overlay content with numerous separate transparent sections (such as overlay content causing an underlying page image or other object to appear to be behind prison bars). As another example, the overlay content may contain an intricate pattern with numerous transparent sections throughout the pattern (such as overlay content appearing as a spider web over an underlying page object).

In some embodiments, a generic package for each advertisement campaign (e.g., a package for a particular frame advertisement for a particular advertiser) may be stored in an advertisement data store associated with the advertisement service, which may be modified by the server prior to sending a modified package to the client device. For example, HTML in the stored package may include macros or placeholders that the server replaces with instance-specific information associated with the publisher's page and/or the page image on which the advertisement will be presented. The placeholder information may relate to, for example, the image size (width and height) of the page image on which the advertisement will be displayed. In other embodiments, the placeholder replacements may occur on the client device, such that the package is retrieved by the server and sent to the client device without modification. While the term “package” is often used as an example herein to refer to overlay content and associated supporting files delivered to a client computing device, it will be appreciated that one or more servers may separately send multiple discrete files (such as an HTML file, image files, a JSON file, and/or others) that collectively make up what is referred to as the contents of the overlay content package described above. Accordingly, the term “package” herein is not intended to be limited to a single file that includes the various components (e.g., HTML, supporting images, etc.) within it.

At block 108, the client device receives the overlay content package (which may be considered an advertisement package, in some embodiments) from the server, including the additional code that causes the client device (e.g., via a browser or other application operating on the client device) to display overlay content in association with the particular designated image on the page. At block 110, the client device executes the additional code in the package (in combination with execution of code previously resident on the page and/or previously delivered by the server, in some embodiments). Executing the code may cause the client device to place a container or drawing canvas over the image within the page, where the container may be sized and positioned on the page such that it covers the image. For example, the container may be sized to completely cover the image, but not extend beyond the image to cover any other page content). In one embodiment, the code then causes the client device to render the HTML content of the overlay content package (potentially including other embedded or associated code) within the newly created container.

The client device may present image or video data from the overlay content package for display within the container, such that an overlay image or video appears to be on top of the underlying page image or within the underlying page image. In some embodiments, the image, animation or video content from the overlay content package may be assembled or arranged by the code of the package to dynamically create a visual advertisement from component image parts. For example, the package may cause the client's browser to create a four-sided “frame” shape with an empty (for example, transparent) center by positioning at least four images, such as images designated in the package as the left side, right side, top and bottom of the frame (which may correspond to the left, right, top and bottom of the container). In order to be adjustable to fit a wide range of underlying image or container shapes and sizes, the package may further include one or more tile images that can be repeated to extend the top, bottom, left and/or right images of the overlay content to the corresponding corner of the container. The code may additionally or alternatively scale one or more images in the overlay content package based on the size and shape of the underlying page image. As will be described below, the overlay content may be presented in a manner such that portions of the container do not include visible content and instead allow the underlying page image to remain visible beneath the container.

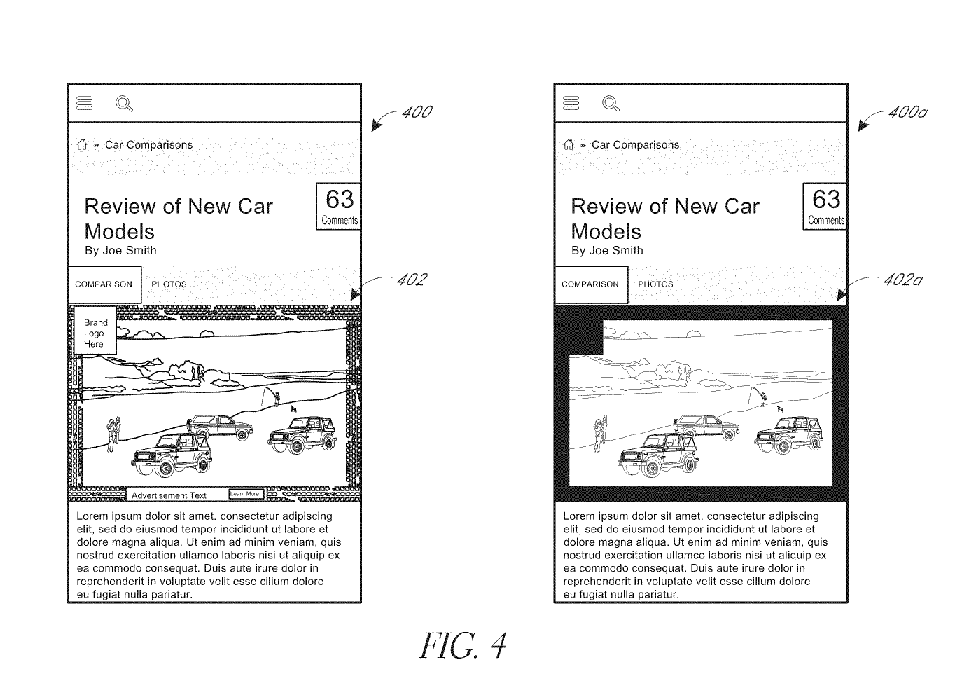

FIG. 1B is a flow diagram of an illustrative method for handling user selection events in association with the displayed overlay content discussed above with respect to FIG. 1A. The illustrative method begins at block 112, which may be performed after block 110 discussed above with respect to FIG. 1A. More specifically, block 112 may occur after an advertisement or other overlay content has been displayed as an overlay on an underlying page image. At block 112, the client device receives a user selection event located within the bounds of the container discussed above. For illustrative purposes, consider overlay content that was presented as a frame around all four sides of an underlying page image (such as will be described with respect to FIG. 4 below), such that the a portion of every side of the image is at least partially covered by the overlay content, but a majority of the underlying image remains visible within the frame shape. In this example, we will assume that the frame was presented within a container, where the container is the same size as the underlying page image and is positioned directly on the image, such that the portions of the container that do not include the frame-shaped overlay content are transparent and unknown to the user. This approach may be preferred to alternative methods of presenting a frame-style overlay advertisement because only one container is required, as opposed to an alternative of using separate containers for each element of the frame (e.g., four containers, one to display each of the top, bottom, left and right of the frame). Furthermore, it may not be possible to maintain interactivity ability with underlying content when using alternative approaches (such as multiple containers) for certain styles of overlay content, such as designs that cannot be constrained to a set of rectangular containers (e.g., overlay content without straight outside edges) and/or that include a large number of interior transparent portions.

In the example above, because the container covers the entire page image, a user selection event (e.g., a click with a cursor in a certain position, or a tap gesture on a touchscreen) that is within the container does not necessarily signal to the client device that the user intended to select the advertisement or other overlay content. Rather, the user is unaware of the presence of the container, only seeing the underlying page image and the visual portions of the overlay content. Thus, the user may have intended to select the overlay content (such as to view more information regarding a product or service advertised in the overlay content), but may instead have intended to select an option associated with the underlying image (such as to view more information regarding an aspect of whatever is depicted in a photo or other image in the original page).

At decision block 114, in some embodiments, the client device may determine if the user selection event is within an advertisement portion of the container, or is instead in a transparent (or undrawn) portion of the container. Code executed in this block may determine whether the precise location of the user's selection (e.g., a cursor position at the time of a mouse click or a touch location associated with a touchscreen selection) is at a position that the code has designated as advertisement content, or is instead at a position designated as a “pass-through” portion of the advertisement's container. In some embodiments, each pixel that is drawn and visible in the container (e.g., all of the image or video content displayed as part of the overlay content) may be treated as advertisement content that, when selected by a user, causes an action associated with the advertisement to be performed (e.g., for the browser to request a landing page URI associated with the advertisement). The remaining portions of the container may be designated as “pass-through” portions. In other embodiments, some portions of the visible overlay content (such as the top portion of a frame where the majority of the eye-catching advertisement content is at the bottom of the frame) may nonetheless be treated by the code as either a “pass-through” portion of the container or as selection “dead space” that results in no action when selected by a user.

In some embodiments, code of the overlay content package may set mapping data, coordinates, boundaries, polygonal regions and/or other data that establishes which portions of the container are designated as selectable advertisement content. This may be set, for example, at the time that the code assembles the overlay content for display or when the overlay content is drawn to the container. In some embodiments, any portion of the container not designated as selectable advertisement content is assumed to be a “pass-through” area, while in other embodiments “pass-through” areas and/or selection “dead space” areas may be explicitly identified or defined.

If the user selection event is determined to be in a portion of the container designated as selectable advertisement content, the method proceeds to block 120, where the client device performs an action associated with the advertisement. For example, the client's browser may request a URI of a webpage associated with the advertisement or other overlay content. If instead the user selection event is determined to be in a portion of the container designated as a “pass-through” area, the method proceeds to block 116. At block 116, code causes the browser or other client device application to send the selection event to the underlying page image.

The selection event may be passed or sent to the underlying page image, in some embodiments, using JavaScript and/or HTML. For example, a token or macro within the HTML of the overlay content package may have been replaced by either the server (before the package was delivered to client device) or at the client device to reference the original page image (or video or other object or element on the page) on which the container and overlay content were placed. A reference to the page image may be placed, for example, in the closure of the overlay content's action. On the client side, JavaScript may invoke an event listener in accordance with World Wide Web Consortium (“W3C”) standards that causes the browser to bind the selection event with the underlying page image. For example, the result of the event listening may be that when the user selection occurs within a pass-through portion of the container, the browser is effectively instructed to select the underlying page image at the corresponding coordinates of the selection. As a result, at block 118, whatever action was set in the original page code of the publisher in association with a selection of the given page image at the given coordinates may automatically occur. This may include, for example, the browser requesting a URI previously associated with the image (such as based on an HTML “href” attribute associated with the image in the original publisher page), displaying pop-up text somewhere within the page, or any other action previously set by the publisher page code.

While reference is often made above to a “page” and a “browser,” it will be appreciated that the disclosure herein is also applicable to contexts other than webpages and web browsers. For example, various other applications, such as applications executable on a mobile device, may present various user interfaces that include native images or video content on which overlay content as described herein may be presented. Various applications are configured to process HTML, including email clients and social media applications, such that only minor modifications, if any, enable the above methods to be implemented in a variety of contexts other than a browser.

As an illustrative, non-limiting example, below is sample Cascading Style Sheets (“CSS”) code that may be used to illustrate aspects of one embodiment:

#ad {

background: rgba(0,0,0,0.3);
display: block;
position: absolute;
width: 420px;
height: 220px;
top: 0;
left: 0;

}

As a further example, below is sample JavaScript code illustrating aspects of the same embodiment:

const img = document.querySelector(‘img’);
img.addEventListener(‘click’, evt => {

evt.preventDefault( );
alert(“I'm an action bound to the img: ” + evt.target.src);

});
document.getElementById(‘ad’).addEventListener(‘click’, evt => {

img.click( )

})

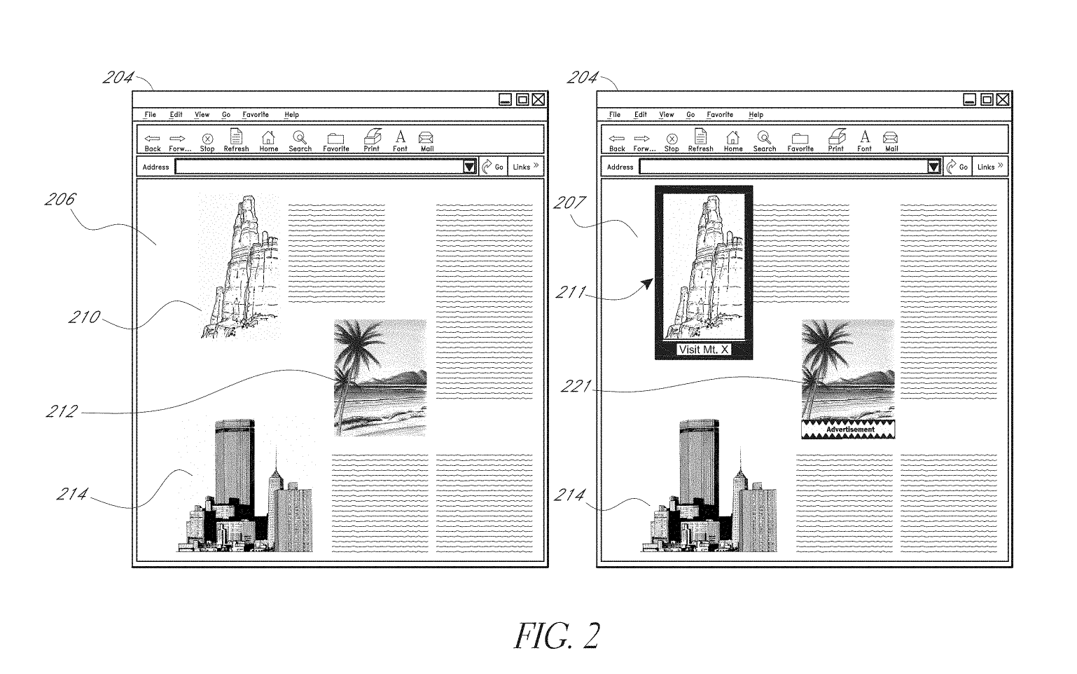

FIG. 2 illustrates a webpage before and after advertisements are displayed as overlay content on (or within) images on the page as a result of code executed by a client device. The page 206 is displayed in a browser window 204. The page in FIG. 2 comprises lines of text (represented in the figure as lines) and images 210, 212 and 214. As will be appreciated, a page may contain many other types of content.

Page 207 is a representation of the page 206 after overlay advertisements have been displayed over images 210 and 212 according to the systems and methods disclosed herein. In this example, the advertisement service's server has determined that images 210 and 212 meet advertiser criteria and other requirements for advertisement placement, and have each had an advertisement associated with the image. Accordingly, advertisements 521 and 523 have been incorporated with content items 511 and 513 respectively. In this example, image 210 has been partially covered by a frame-shaped advertisement unit 211 that covers the top, bottom and sides of the image 210, with the majority of the image remaining visible and unaltered within the center of the frame. In contrast, image 212 has been partially covered with a more traditional rectangular banner-style in-image advertisement. Either the client device (via execution of JavaScript or other code) or the advertisement service's server (based on image and page data received from the client device, as discussed above) determined that image 214 was not suitable for placement of an overlay advertisement (e.g., for not meeting advertiser criteria, not being properly licensed, not receiving a sufficiently high advertiser bid, and/or other factors).

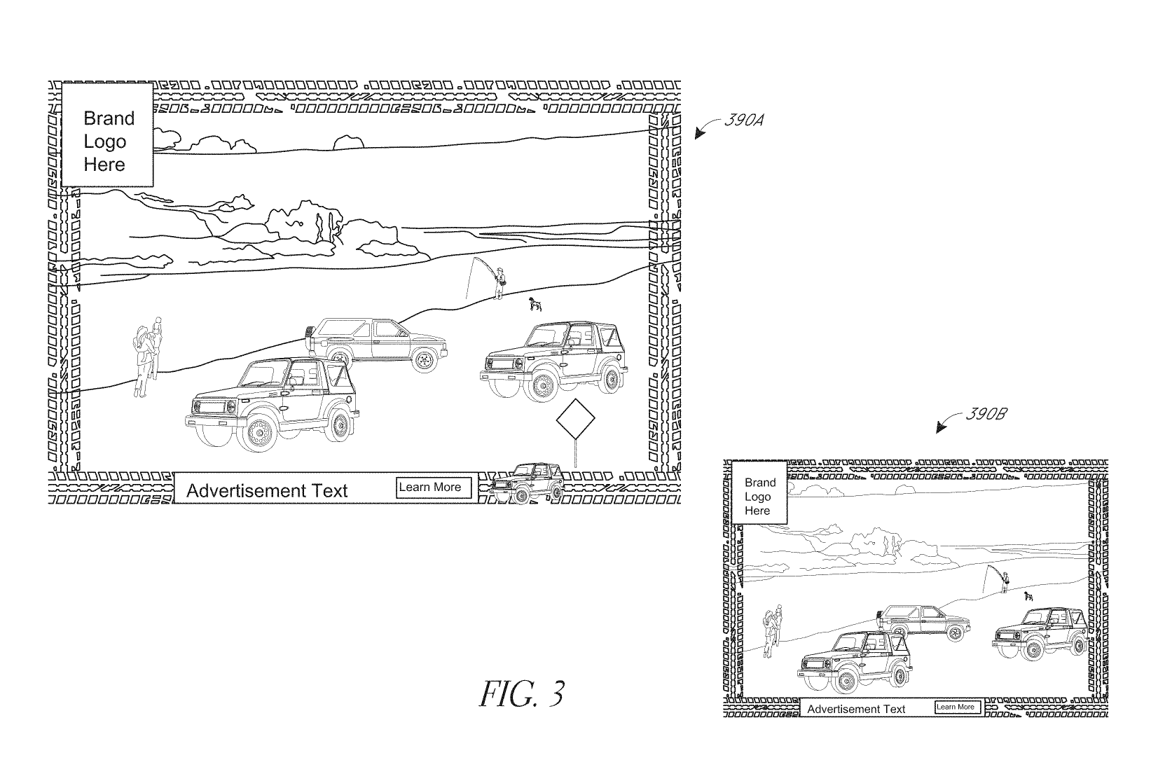

FIG. 3 illustrates two sample instances of a frame-shaped advertisement unit, according to one embodiment, displayed as partially transparent overlays on two differently sized images. Instance 390A and 390B may both be the result of applying the same overlay content package associated with the same advertisement campaign, but may appear differently based on the execution of the package's code with respect to differing underlying image sizes. Alternatively, the two instances may be the result of different overlay content packages, where each package is associated with the same campaign but is intended for underlying images in different size ranges. As illustrated, instance 390A shows an underlying image that has a “frame” style overlay advertisement presented on top of the image (with the frame appearing as tire marks that includes transparent portions through which the underlying image is visible). The advertisement portions of instance 390A include an advertiser logo in the top left, advertisement text along the bottom, and a truck and sign graphic near the bottom right. As will be appreciated, the instance 390A (including the image and advertisement) may appear within a publisher page or an application user interface, similar to the examples described herein with respect to FIGS. 2 and 4. The overlay content in instance 390A may have been assembled dynamically by a client computing device at the time of display by executing code in an overlay content package that appropriately placed the brand logo, bottom banner portion, truck and sign image, and various repeated tiles of tire marks to fit the dimensions of the underlying photograph of trucks on a beach.

Instances 390A and 390B would typically not appear on the same webpage as each other at the same time, but are shown next to each other in FIG. 3 for comparative purposes. In contrast to instance 390A, instance 390B appears slightly differently (such as the lack of the truck and sign graphic, and a smaller brand logo in the upper left). The difference between the two instances may be due to the difference in the underlying image sizes, with the underlying image in instance 390A being larger than the underlying image in instance 390B. In one embodiment, for example, certain visual elements of a given advertisement unit may only be displayed when the underlying image on which the advertisement will be placed exceeds a certain minimum pixel width and/or pixel height threshold. While not illustrated, one or more visual portions of the overlay content may be animated, such as the truck in instance 390A moving and animating to appear to drive across a portion of the overlaid frame.

FIG. 4 illustrates a sample display of an overlay frame-shaped advertisement displayed on an image 402 embedded within a webpage or application user interface 400, as well as a graphical representation of the areas of the display 402a in which a user selection event will register as a selection of the advertisement. User interface 400 largely includes publisher content (e.g., the publisher's page with car review information, a top navigation bar, and a photo 402), which has been supplemented at the time of display to present a frame advertisement over the image 402 that is included in the page. User interface 400 illustrates how the page and advertisement may appear to the user, while representation 400a is a visual markup that represents a portion 402a of the interface as being configured to receive advertisement-related user selection actions. The area 402a that appears shaded is not displayed to a user, but rather is for illustrative purposes herein. According to methods described above, if a user “clicks” or makes a selection in the page image 402 (the photo of cars on a beach) other than in the shaded overlay region, the user will be presented with a new page or whatever other action was associated with the image by the publisher that authored the original page. The user will only be presented with additional advertisement-related content (such as being shown a landing page associated with the advertisement) if the user selection is within the shaded region 402a. As described above, attempting to display an advertisement unit of this shape and size according to existing techniques would typically block the entire underlying image from user interaction (e.g., the entire image 402 would be shaded in representation 400a), which is one technical problem solved by aspects of the present disclosure.

While in-image advertisements are described above as examples, it will be appreciated that aspects of the disclosure provide improvements for many other types of overlay content. For example, overlay content as described herein may be presented over video content or other content of a webpage or user interface besides a static image. In some embodiments, an “in-screen” advertisement may be presented instead of an “in-image” advertisement. For example, overlay content may frame a user's entire display screen (such as a screen of a mobile phone or other computing device while a browser or other application is operating on the device), partially covering the page content or other content that is onscreen at the time. This may be accomplished, for example, by sizing a container that includes the overlay content to cover the entire screen, while still enabling “pass-through” user event functionality as described herein. In one embodiment, overlay content that is bound to the screen as opposed to a specific image or other object may be configured to visually collapse or minimize after a predetermined time (such as five seconds), or in response to a user request to hide the overlay content.

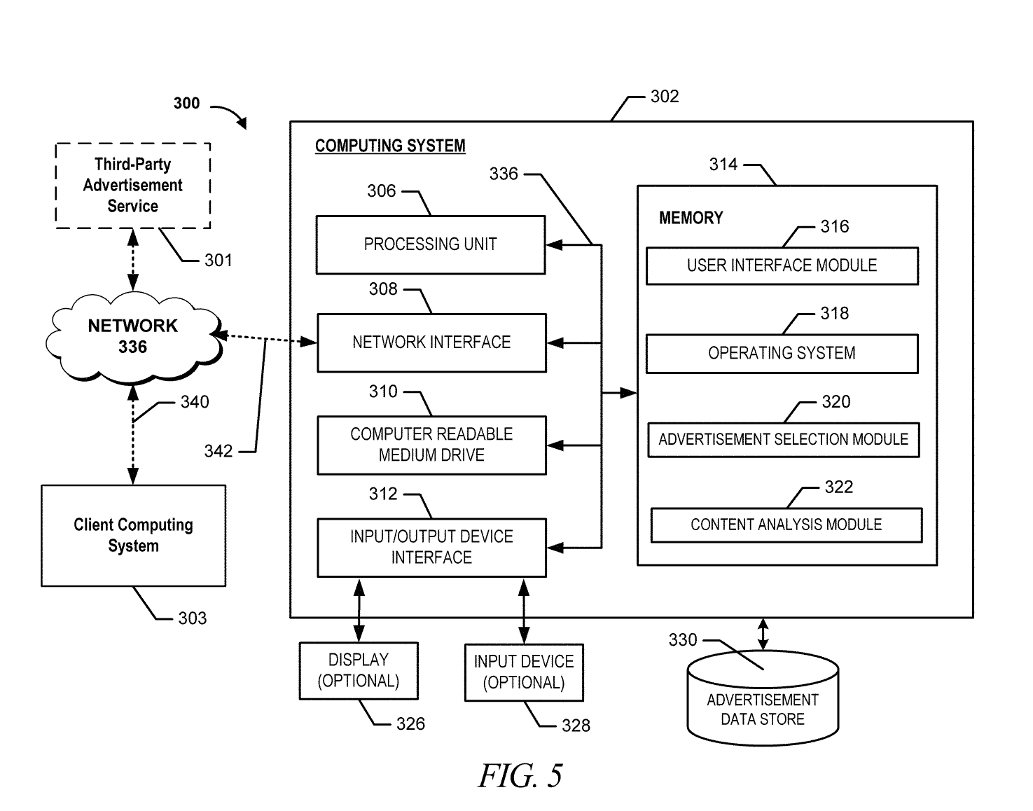

FIG. 5 illustrates a general architecture of a computing environment 300, according to some embodiments. As depicted in FIG. 5, the computing environment 300 may include a computing system 302. The general architecture of the computing system 302 may include an arrangement of computer hardware and software components used to implement aspects of the present disclosure. The computing system 302 may include many more (or fewer) elements than those shown in FIG. 5. It is not necessary, however, that all of these generally conventional elements be shown in order to provide an enabling disclosure. In some embodiments, the computing system 302 may be an example of what is referred to as the server or advertisement service's system above.

As illustrated, the computing system 302 includes a processing unit 306, a network interface 308, a computer readable medium drive 310, an input/output device interface 312, an optional display 326, and an optional input device 328, all of which may communicate with one another by way of a communication bus 336. The processing unit 306 may communicate to and from memory 314 and may provide output information for the optional display 326 via the input/output device interface 312. The input/output device interface 312 may also accept input from the optional input device 328, such as a keyboard, mouse, digital pen, microphone, touch screen, gesture recognition system, voice recognition system, or other input device known in the art.

The memory 314 may contain computer program instructions (grouped as modules or components in some embodiments) that the processing unit 306 may execute in order to implement one or more embodiments described herein. The memory 314 may generally include RAM, ROM and/or other persistent, auxiliary or non-transitory computer-readable media. The memory 314 may store an operating system 318 that provides computer program instructions for use by the processing unit 306 in the general administration and operation of the computing system 302. The memory 314 may further include computer program instructions and other information for implementing aspects of the present disclosure. For example, in one embodiment, the memory 314 may include a user interface module 316 that generates user interfaces (and/or instructions therefor) for display upon a computing system, e.g., via a navigation interface such as a browser or application installed on the computing system 302 or the client computing system 303.

In some embodiments, the memory 314 may include an advertisement selection module 320 and content analysis module 322, which may be executed by the processing unit 306 to perform operations according to various embodiments described herein. The modules 320 and/or 322 may access the data store 330 in order to retrieve data described above and/or store data. The data store may be part of the computing system 302, remote from the computing system 302, and/or may be a network-based service. The advertisement data store 330 may store various advertisement or other overlay content and information, such as images, video, text, associated rules for when to display given overlay content, bid information, keyword information, code packages that instruct a browser or application how to display given overlay content, and/or other data or content.

In some embodiments, the network interface 308 may provide connectivity to one or more networks or computing systems, and the processing unit 306 may receive information and instructions from other computing systems or services via one or more networks. In the example illustrated in FIG. 5, the network interface 308 may be in communication with a client computing system 303 via the network 336, such as the Internet. In particular, the computing system 302 may establish a communication link 342 with a network 336 (e.g., using known protocols) in order to send communications to the computing system 303 over the network 336. Similarly, the computing system 303 may send communications to the computing system 302 over the network 336 via a wired or wireless communication link 340. In some embodiments, the computing system 302 may additionally communicate via the network 336 with an optional third-party advertisement service 301, which may be used by the computing system 302 to retrieve advertisement data to be delivered to a client computing system 303. Depending on the embodiment, the computing system 302 may be configured to retrieve advertisement data from either advertisement data store 330 or third-party advertisement service 301 depending on various information, such as publisher page information, image information, advertiser preference, comparison of bid information, and/or other factors.

Those skilled in the art will recognize that the computing systems 302 and 303 may be any of a number of computing systems including, but not limited to, a laptop, a personal computer, a personal digital assistant (PDA), a hybrid PDA/mobile phone, a mobile phone, a smartphone, a wearable computing device, an electronic book reader, a digital media player, a tablet computer, a gaming console or controller, a kiosk, an augmented reality device, another wireless device, a set-top or other television box, one or more servers, and the like. The client computing system 303 may include similar hardware to that illustrated as being included in computing system 302, such as a display, processing unit, network interface, memory, operating system, etc.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm elements described in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A computer system comprising:
memory; and
a processor in communication with the memory and configured with processor-executable instructions to perform operations comprising:
receiving a page for display, wherein the page includes page content for display and a reference to a page image, wherein the page image comprises an image file to be displayed in association with the page content;
receiving a data package from a server, wherein the data package includes one or more images and executable code that instructs the computer system to present the one or more images in a manner specified in the executable code;
as a result of executing the executable code included in the data package:
placing a container object over the page image as displayed on the page;
generating overlay content for display over the page image, wherein the overlay content is generated for display over the page image by arranging the one or more images in the data package for display within the container object according to the executable code included in the data package,
wherein at least a portion of the page image is visible beneath the container object, wherein the at least a portion of the page image that is visible corresponds to a portion of the container object that does not include overlay content for display;
receiving a user selection event within the container object;
determining that the user selection event is within the portion of the container object that does not include displayed overlay content; and
based on the determination that the user selection event is within the portion of the container object that does not include displayed overlay content, causing an action associated with the page image to be performed, wherein the action to be performed is determined from code of the page.

2. The computer system of claim 1, wherein the operations further comprise:
receiving a second user selection event within the container object;
determining that the second user selection event is within a portion of the container object that includes displayed overlay content; and
based on the determination that the user selection event is within the portion of the container object that includes displayed overlay content, causing a second action specified in code of the data package to be performed instead of the action associated with the page image as specified in the code of the page.

3. The computer system of claim 2, wherein the overlay content comprises an advertisement, and wherein the action specified in the code of the data package comprises sending a network request for a uniform resource identifier associated with the advertisement.

4. The computer system of claim 1, wherein the overlay content as displayed appears as a four-sided frame shape with a transparent center portion, such that visible overlay content appears at each of a leftmost portion, rightmost portion, topmost portion and bottommost portion of at least one of the container object or the page image, wherein the at least a portion of the page image that is visible beneath the container object is located beneath the transparent center portion of the four-sided frame shape.

5. The computer system of claim 1, wherein determining that the user selection event is within the portion of the container object that does not include displayed overlay content comprises comparing coordinates of the user selection event with mapping data in the data package, wherein the mapping data defines at least one portion of the container object as selectable overlay content with reference to one or more of: coordinates or polygonal regions.

6. A computer-implemented method comprising:
as implemented by one or more computing devices configured with specific executable instructions,
causing display of a user interface that includes a media item and additional content, wherein the user interface comprises one of an application user interface or a webpage, and wherein the media item is one of an image or a video;
sending a request, over a network, for overlay content to be presented in association with the media item;
receiving, over the network, one or more visual media assets and computer-executable display instructions associated with the one or more visual media assets;
as a result of executing the computer-executable display instructions received over the network:
placing a container object over the media item within the user interface;
generating overlay content for display, wherein the overlay content is generated for display over the media item by arranging the one or more visual media assets for display within the container object, wherein the overlay content is displayed such that at least a portion of the media item beneath the container object remains visible, wherein the overlay content is displayed on two or more sides of the portion of the media item that remains visible;
receiving a user selection event within the container object;
determining that a location of the user selection event corresponds to the portion of the media item that remains visible beneath the container object; and
based on the determination that the location of the user selection event corresponds to the portion of the media item that remains visible, causing a first action associated with the media item to be performed instead of a second action associated with the overlay content.

7. The computer-implemented method of claim 6 further comprising:
receiving a second user selection event within the container object;
determining that a location of the second user selection event is within a portion of the container object that includes displayed overlay content; and
based on the determination that the user selection event is within the portion of the container object that includes displayed overlay content, causing the second action associated with the overlay content to be performed instead of the first action associated with the media item.

8. The computer-implemented method of claim 6, wherein the at least a portion of the media item that remains visible beneath the container object is surrounded by visible overlay content on each of a left side, right side, top and bottom of the portion of the media item.

9. The computer-implemented method of claim 6, wherein the container object is sized to be at least as large as a display size of the media item, and wherein the container object is positioned to cover the entire media item.

10. The computer-implemented method of claim 6, wherein the location of the user selection event corresponds to one of (a) a touch location associated with a touchscreen selection or (b) a cursor location at a time of a mouse click.

11. The computer-implemented method of claim 6, further comprising invoking an event listener that causes a browser application to bind a selection event associated with the overlay content to the media item.

12. The computer-implemented method of claim 6, wherein the overlay content generated for display changes appearance over a time period, such that a first portion of the media item that is visible at a first time within the time period is covered by the overlay content during a second time within the time period.

13. The computer-implemented method of claim 12 further comprising:
performing the first action in response to a second user selection at a location corresponding to the first portion of the media item during the first time period; and
performing the second action in response to a third user selection at a location corresponding to the first portion of the media item during the second time period.

14. A computer system comprising:
an electronic data store that stores a plurality of data packages, wherein each of the plurality of data packages includes different media assets; and
a processor in communication with the electronic data store and configured with processor-executable instructions to perform operations comprising:
receiving, from a client computing device over a network, information regarding an image embedded within a page, wherein the information is sent by the client computing device as a result of the client computing device executing code associated with the page when presenting the page for display;
selecting overlay content to present in association with the image based at least in part on the information regarding the image received from the client computing device;
retrieving, from the electronic data store, a data package associated with the selected overlay content for delivery to the client computing device, wherein the data package includes two or more visual media assets and computer-executable display instructions that when executed by a computing device cause the computing device to arrange the two or more visual media assets to form dynamically arranged overlay content;
modifying the data package retrieved from the electronic data store to generate a modified data package, wherein the data package is modified based at least in part on the information regarding the image received from the client computing device; and
sending the modified data package to the client computing device over the network, wherein execution of code in the modified data package causes the client computing device to present the dynamically arranged overlay content over the image embedded within the page, such that visual media assets of the data package are positioned on each two or more sides of an empty overlay portion that does not include any visual media asset,
wherein the code of the modified data package causes user interaction with a first portion of the image beneath a visual media asset to be blocked, wherein the code of the modified data package further enables user interaction with a second portion of the image beneath the empty overlay portion, such that user interaction with the second portion of the image invokes an action associated with the image as defined in code of the page.

15. The computer system of claim 14, wherein the information received from the client computing device includes (a) image dimensions of the image, (b) the location of the image in the page, and (c) information associated with additional content of the page other than the image.

16. The computer system of claim 14, wherein the overlay content is an advertisement, and wherein selecting the overlay content to present includes selecting the advertisement from among a plurality of advertisements based on two or more of: a size of the image, a name of the image, metadata associated with the image, or contextual information determined from text appearing near the image in the page.

17. The computer system of claim 14, wherein modifying the data package includes replacing one of a macro or a placeholder within the data package based on a size of the image.

18. The computer system of claim 14, wherein modifying the data package includes inserting a reference to the image in association with an action defined in code of the data package.

19. The computer system of claim 14, wherein causing the computing device to arrange the two or more visual media assets comprises repeating a tile image in a plurality of positions to fit one or more dimensions of the image embedded within the page.

20. The computer system of claim 14, wherein the data package includes at least HTML and JavaScript that collectively specify an arrangement of the two or more visual media assets to form the dynamically arranged overlay content in a frame shape that surrounds a center portion of the image on all sides, wherein the center portion of the image is positioned beneath the empty overlay portion.
